(19) United States
(12) Patent Application Publication
(10) Pub. No.: US 2014/0240471 A1
(43) Pub. Date: Aug. 28, 2014

(54) METHOD, DEVICE AND APPARATUS FOR GENERATING STEREOSCOPIC IMAGES USING A NON-STEREOSCOPIC CAMERA

(71) Applicant: SAMSUNG ELECTRONICS CO., LTD, Gyeonggi-do (KR)

(72) Inventors: Mysore Ravindra Srinivasa, Bangalore (IN); Pavan Sudheendra, Bangalore (IN); Sanjay Narasimha Murthy, Bangalore (IN); Rajaram Hanumantacharya Naganur, Bangalore (IN)

(73) Assignee: Samsung Electronics Co., Ltd, Gyeonggi-do (KR)

(21) Appl. No.: 13/861,298

(22) Filed: Apr. 11, 2013

(30) Foreign Application Priority Data
Feb. 28, 2013 (IN) 1457/CHE/2012

(51) Int. Cl. H04N 13/02; H04N 5/232

(52) U.S. Cl. CPC H04N 13/0217; H04N 5/23293
USPC 348/50

(57) ABSTRACT

A method, device and apparatus for generating stereoscopic images using a non-stereoscopic camera. In one embodiment, a first image of a scene is captured using a non-stereoscopic camera of an electronic device. In order to create a stereoscopic image, two images are captured from two different viewpoints. In order to achieve this, a guided preview screen is displayed on a display unit of the electronic device to guide the user in capturing a second image. The guided preview screen indicates a direction in which the electronic device has to be moved to capture the second image. The second image of the scene is captured using the non-stereoscopic camera once the guided preview screen indicates that the second image can be captured. A stereoscopic image of the scene is produced and displayed on the display unit using the first image and the second image.

### CROSS-REFERENCE TO RELATED APPLICATION(S) AND CLAIM OF PRIORITY

The present application is related to and claims the benefit under 35 U.S.C. §119(a) to an Indian Provisional Patent Application filed in the India Patent Office on Apr. 11, 2012 which was assigned Serial No. 1457/CHE/2012 and an earlier Indian Application Number, 1457/CHE/2012 filed on Feb. 28, 2013, the disclosure of which is hereby incorporated by reference herein.

### TECHNICAL FIELD OF THE INVENTION

The present disclosure relates to the field of stereoscopic image generation, and more particularly relates to a method, device and apparatus for generating stereoscopic images using a non-stereoscopic camera.

### BACKGROUND OF THE INVENTION

A stereoscopic image is realized by the principle of stereo vision through two eyes of a human. Binocular parallax caused by the distance of about 65 mm between two eyes of a human may serve as an important factor to perceive a Three-dimensional (3D) effect. A 3D effect may be expressed in a way that the same image as an actual image appearing to the human eyes is shown to two eyes of the human.

Generally, a stereoscopic image is created using stereo images. Stereo images are captured using a stereo camera (also commonly known as a stereoscopic 3D camera). For example, a stereo camera is a special type of camera designed to capture stereo images. The stereo camera may comprise two lenses separated by the distance between the two eyes of a human. A stereo image captured by a left lens is shown to only a left eye, and a stereo image captured by a right lens is shown to only a right eye. Today, most of the cameras in use are non-stereoscopic cameras (e.g., camera in a smart phone or tablet) which do not allow a user to capture stereoscopic images, thereby causing inconvenience to the user.

### SUMMARY OF THE INVENTION

To address the above-discussed deficiencies of the prior art, it is a primary object to provide a method, device and apparatus for generating stereoscopic images using a non-stereoscopic camera.

The present invention also provides method, device and apparatus for accurately capturing images from different viewpoints for any scene to generate stereoscopic images using a non-stereoscopic camera.

The present invention also provides method, device and apparatus for moving a non-stereoscopic camera in a right way to accurately capture images from different viewpoints for any scene, thereby generating stereoscopic images using a non-stereoscopic camera.

The present invention also provides method, device and apparatus for guiding a user to move a non-stereoscopic camera in a right way so as to accurately capture images from different viewpoints for any scene, thereby generating stereoscopic images using a non-stereoscopic camera.

In one aspect, a method includes capturing a first image of a scene using a non-stereoscopic camera of an electronic device. The method further includes computing a depth of the scene, and displaying a preview frame of the scene in juxtaposition with a blank display region on a display unit of the electronic device based on the computed depth of the scene. Furthermore, the method includes capturing a second image of the scene when the blank display region disappears from the display unit. Moreover, the method includes generating a stereoscopic image of the scene using the first image and the second image. Additionally, the method includes displaying the stereoscopic image of the scene on the display unit of the electronic device.

In another aspect, a device includes a non-stereoscopic camera, a stereoscopic image generation unit and a display unit. The non-stereoscopic camera is configured to capture a first image of a scene. The stereoscopic image generation unit is configured to compute a depth of the scene for producing a stereoscopic effect and provide a guided preview screen which displays a preview frame of the scene in juxtaposition with a blank display region, where the size of the blank display region is based on the computed depth of the scene. When the guided preview screen is entirely occupied by the preview frame, the stereoscopic image generation unit is configured to generate a capture signal to capture a second image of the scene. The non-stereoscopic camera is configured to capture a second image of the scene based in the capture signal. Using, the first image and the second image, the stereoscopic image generation unit is configured to generate a stereoscopic image of the scene.

In yet another aspect, an apparatus includes a microprocessor, and a memory coupled to the microprocessor, where the memory includes a guided preview module and an image processing module stored in the form of an executable program. The microprocessor, when executing the executable program, is configured for computing a depth of a scene whose first image is captured from a first viewpoint using a non-stereoscopic camera. The microprocessor is further configured for generating a guided preview screen which displays a preview frame of the scene in juxtaposition with a blank display region, where the size of the blank display region corresponds to the computed depth of the scene. The microprocessor is also configured for generating a capture signal to capture a second image of the scene when the guided preview screen is entirely occupied by the preview frame in order that the second image of the scene is captured from a second viewpoint using the non-stereoscopic camera. Moreover, the microprocessor is configured for generating a stereoscopic image of the scene using the first image and the second image.

Other features of the embodiments will be apparent from the accompanying drawings and from the detailed description that follows.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A illustrates a block diagram of an electronic device configured for producing stereoscopic images using a non-stereoscopic camera, according to one embodiment.

FIG. 1B is an exploded view of a stereoscopic image generation unit such as those shown in FIG. 1A, according to one embodiment.

FIG. 2 is a process flowchart illustrating an example method of producing a stereoscopic image from images captured using the non-stereoscopic camera, according to one embodiment.

FIG. 3 is a process flowchart illustrating a detailed method of capturing a second image of a scene for producing a stereoscopic image, according to one embodiment.

FIG. 4 is a schematic view illustrating capturing of a first image and a second image from different viewpoints using the non-stereoscopic camera, according to one embodiment.

FIGS. 5A to 5C are screenshot views of a guided preview screen assisting a user to capture a second image subsequent to a first image of a scene.

FIGS. 6A and 6B are screenshot views of a guided preview screen displaying whether the electronic device is shifted in a correct direction or a wrong direction.

FIG. 7 is a process flowchart illustrating an example method of computing a resultant motion vector to determine movement of a preview frame of a scene, according to one embodiment.

FIG. 8 is a screenshot depicting constituent motion vectors and a resultant motion vector associated with a preview frame.

FIG. 9 is a process flowchart illustrating an example method of post processing a second image with respect to a first image, according to one embodiment.

The drawings described herein are for illustration purposes only and are not intended to limit the scope of the present disclosure in any way.

### DETAILED DESCRIPTION OF THE INVENTION

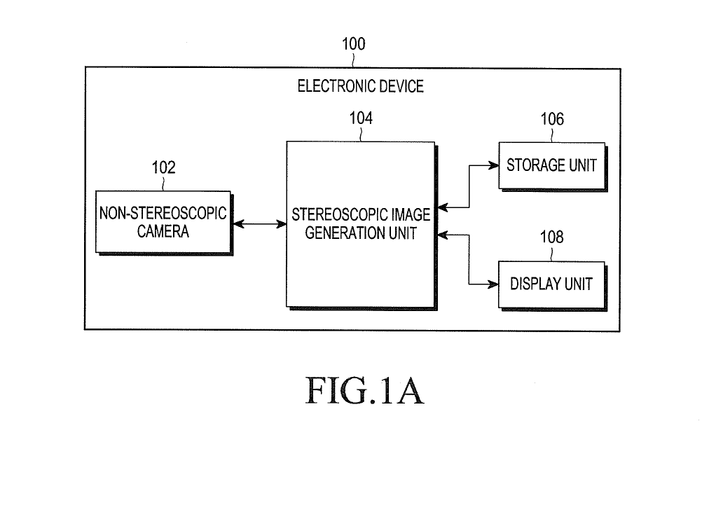

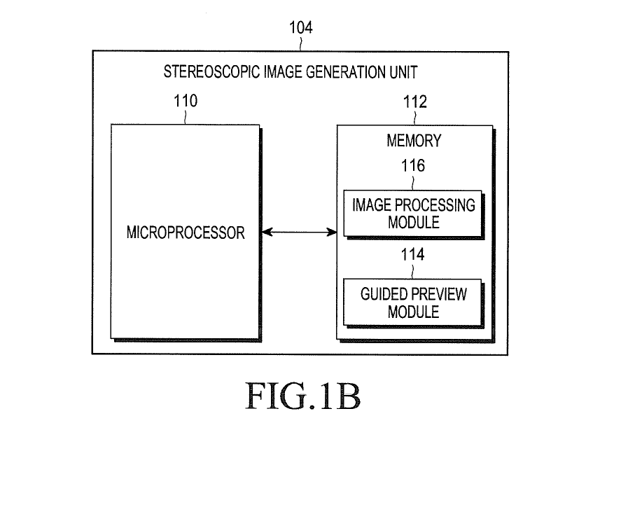

FIGS. 1A through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The present disclosure provides a method, device and apparatus for capturing stereoscopic images using a non-stereoscopic camera. In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the embodiments, and it is to be understood that other embodiments may be utilized and that changes may be made without departing from the scope of the present disclosure. The following detailed description is, therefore, not to be taken in a limiting sense, and the scope of the present disclosure is defined only by the appended claims.

FIG. 1A illustrates a block diagram of an electronic device 100 configured for producing stereoscopic images using a non-stereoscopic camera 102, according to one embodiment. In FIG. 1A, the electronic device 100 includes a non-stereoscopic camera 102, a stereoscopic image generation unit 104, a storage unit 106, and a display unit 108. The electronic device 102 may be a mobile phone, smart phone, digital camera, tablet computer, phablet, or any other device with the non-stereoscopic camera 102. The non-stereoscopic camera 102 may be a single lens camera having capability to capture Two-dimensional (2D) images.

The stereoscopic image generation unit 104 is configured for triggering a signal to the non-stereoscopic camera 102 to capture images based on an input from a user. In some embodiments, the stereoscopic image generation unit 104 may trigger a signal to the non-stereoscopic camera 102 to capture images in 2D mode or 3D mode.

For a 3D mode, the non-stereoscopic camera 102 is configured for capturing multiple images of same scene from different viewpoints. The stereoscopic image generation unit 104 is also configured for displaying a guided preview screen on the display unit 108 for capturing multiple images from different viewpoints. For example, in capturing images for producing a stereoscopic image of a scene, the guided preview screen would assist the user in automatically capturing an image (hereinafter referred to as ‘second image’) of the same scene from another viewpoint after capturing an image (hereinafter referred to as ‘first image’) of the scene from a first viewpoint.

The stereoscopic image generation unit 104 is also configured for processing the captured images and storing the captured images in the storage unit 106. For the images that are captured from different viewpoints, the stereoscopic image generation unit 104 is configured for processing the images of the same scene to create a stereoscopic image of the scene. The stereoscopic image generation unit 104 can be implemented as software, hardware, or some combination of software and hardware. For example, the stereoscopic image generation unit 104 could be implemented as a part of an application specific integrated circuit (ASIC). As another example, the stereoscopic image generation unit 104 may be capable of accessing instructions that are stored on a computer readable medium and executing those instructions on a microprocessor, in order to implement one or more embodiments of the present disclosure.

The display unit 108 is configured for displaying the guided preview screen, preview frame, and captured and stored images (e.g., non-stereoscopic image and stereoscopic image). In some embodiments, the display unit 108 is configured for receiving touch based input from user. The storage unit 106 may be a volatile memory or a non-volatile memory storing non-stereoscopic images and stereoscopic images.

FIG. 1B is an exploded view of the stereoscopic image generation unit 104 such as shown in FIG. 1A, according to one embodiment. The stereoscopic image generation unit 104 includes a microprocessor 110 and a memory 112 coupled to the microprocessor 10. The memory 112 includes a guided preview module 114, and an image processing module 116 stored in the form of an executable program. The microprocessor 110 is configured for executing the executable program to produce stereoscopic images of a scene. For example, when the microprocessor 110 executes the executable program, the guided preview module 114 enables the microprocessor 110 to compute a depth of a scene whose first image is captured from a first viewpoint by the non-stereoscopic camera 102. The guided preview module 114 also enables the microprocessor 110 to generate a guided preview screen displaying a preview frame of the scene in juxtaposition with a blank display region. In some embodiments, the size of the blank display region corresponds to the computed depth of the scene.

Further, the guided preview module 114 enables the microprocessor 110 to decrease the size of the blank display region and increase the size of the preview frame when the non-stereoscopic camera 102 is moved by the user in the correct direction. Furthermore, the guided preview module 114 enables the microprocessor 110 to notify the user when the non-stereoscopic camera 102 is moved in an incorrect direction.

When the guided preview screen is entirely occupied by the preview frame, the guided preview module 114 enables the microprocessor 110 to generate a capture notification to capture a second image of the scene. Based on the capture notification, the non-stereoscopic camera 102 captures the second image of the scene from a second viewpoint. The image processing module 116 enables the microprocessor 110 to generate a stereoscopic image of the scene using the first image and the second image. The operation of the stereoscopic image generation unit 104 is explained in greater detail in the description that follows.

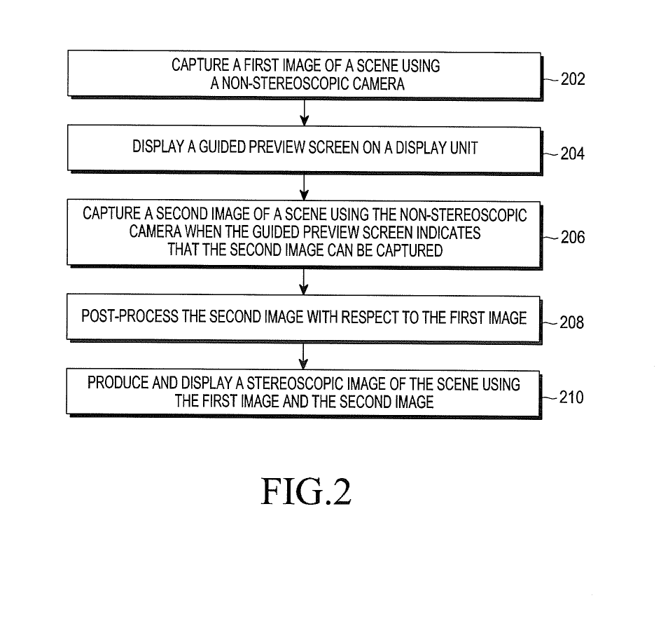

FIG. 2 is a process flowchart illustrating a high level method of producing a stereoscopic image from images captured using the non-stereoscopic camera 102, according to one embodiment. At operation 202, a first image of a scene is captured using the non-stereoscopic camera 102. In some embodiments, the non-stereoscopic camera 102 captures the first image when a user triggers a signal to capture the first image of the scene. In these embodiments, the stereoscopic image generation unit 104 senses the signal to capture the first image and instructs the non-stereoscopic camera to capture the first image. At operation 204, a guided preview screen is displayed on the display unit 108 to guide the user in automatically capturing a second image. In order to create a stereoscopic image, two images are captured from two different viewpoints, i.e., a right camera viewpoint and a left camera viewpoint. If the first image is captured from a right camera viewpoint, then the second image is captured from a left camera viewpoint.

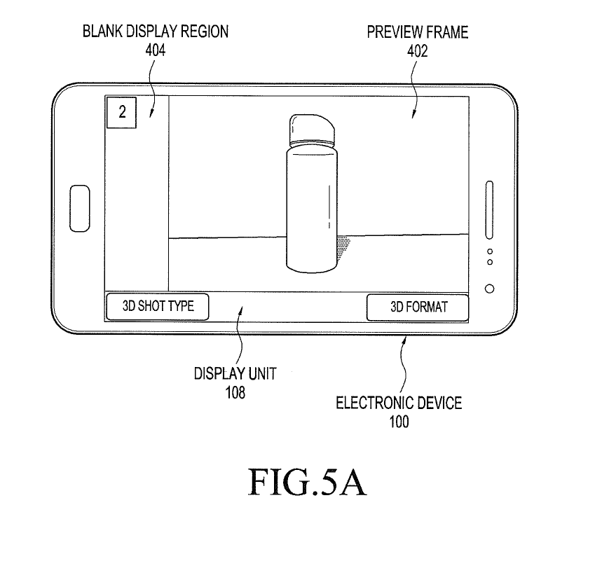

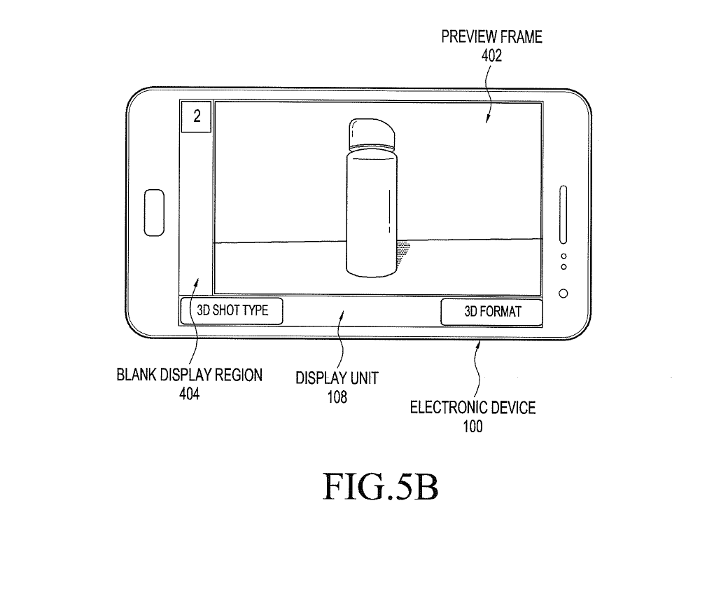

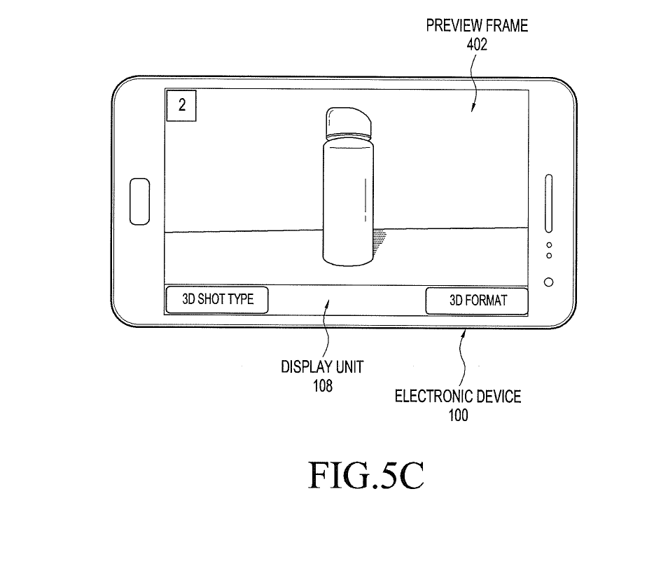

Since the electronic device 100 employs a single non-stereoscopic camera (e.g., the non-stereoscopic camera 102), the electronic device 100 is to be displaced from the position where the first image was captured in order to capture the second image from another viewpoint. According to the present disclosure, the stereoscopic image generation unit 104 determines the distance by which the electronic device 100 is to be moved upon capturing the first image and displays the guided preview screen on the display unit 108. An example guided preview screen is illustrated in FIGS. 5A-5C.

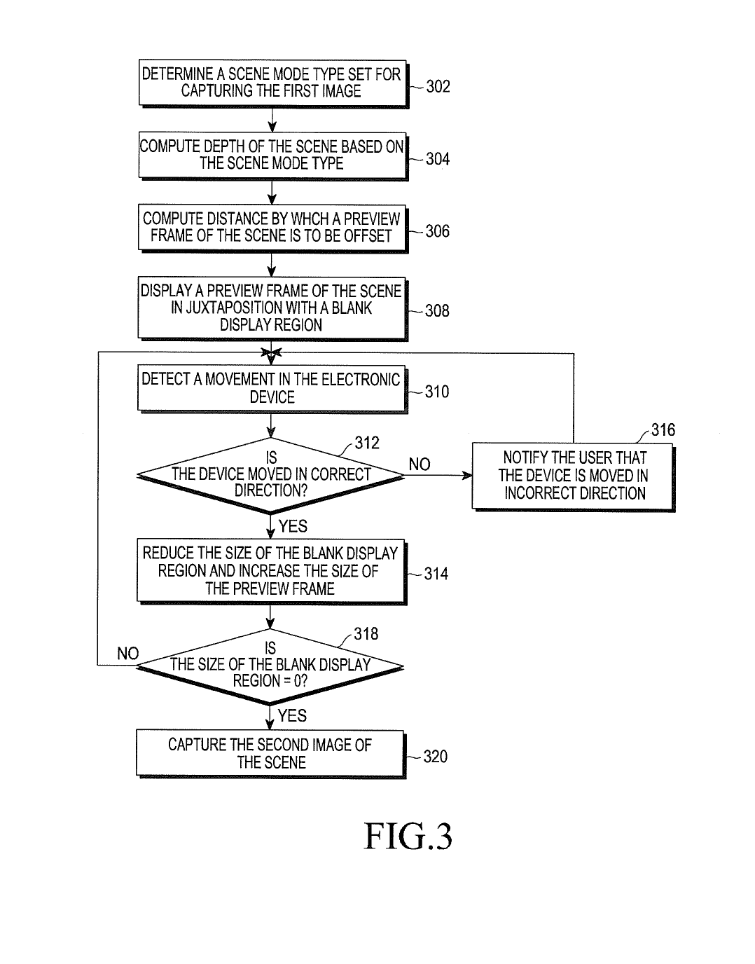

In some embodiments, the guided preview screen indicates the direction in which the electronic device 100 has to be moved to capture the second image and distance by which the electronic device 100 is to be displaced. For example, if the first image is captured from a right camera viewpoint, the guided preview frame indicates that the electronic device 100 is to be moved in the left direction to capture the second image. In such a situation, if the user shifts the electronic device 100 in the first direction, the guide preview frame indicates that the direction in which the electronic device 100 is moved is correct. However, if the user moves the electronic device 100 in the second direction, the guide preview frame indicates that the direction in which the electronic device 100 is moved is incorrect. The guided preview screen may also display a distance by which the electronic device 100 is to be shifted to capture the second image on the display unit 108. This would assist the user in accurately capturing the second image from a different viewpoint. The process operations performed by the stereoscopic image generation unit 104 to guide the user in capturing the second image are illustrated in FIG. 3.

At operation 206, the second image of the scene is automatically captured using the non-stereoscopic camera 102 once the electronic device 100 is moved by the required distance. In some embodiments, when the user moves the electronic device 100 as directed through the guided preview screen, the stereoscopic image generation unit 104 determines that the second image can be captured. In one embodiment, the stereoscopic image generation unit 104 instructs the non-stereoscopic camera 102 to capture the second image of the scene. In an alternate embodiment, when the stereoscopic image generation unit 104 generates a capture notification to capture the second image, the user may trigger a signal to capture the second image of the scene. Accordingly, the stereoscopic image generation unit 104 senses the signal triggered by the user and instructs the non-stereoscopic camera 102 to capture the second image of the scene.

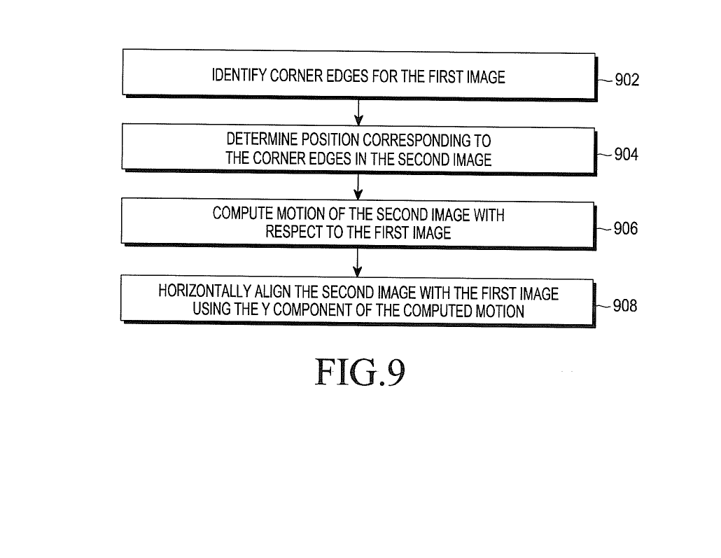

At operation 208, the second image is post-processed with respect to the first image. The first image and the second image should have perfect horizontal alignment for better stereoscopic effect. If the second image is horizontally misaligned, stereoscopic image generation unit 104 post processes the second image to correct horizontal alignment with respect to the first image. In one implementation, the second image is post processed using an image rectification algorithm. The operations performed by the stereoscopic image generation unit 104 to post-process the second image are illustrated in FIG. 9. In an alternate embodiment, multiple post-processed images are generated by combining each of intermediate preview frames that are received along the correct direction with the first image. The multiple post processed images have perfect horizontal alignment with the first image. Thus, the user may be provided an option to select any of the multiple post-processed images to generate a stereoscopic image.

At operation 210, a stereoscopic image of the scene is produced and displayed on the display unit 108 using the first image and the second image. A stereoscopic image produced by the stereoscopic image generation unit 104 is a combination of the first image and the second image in a single format that, when viewed on certain types of display devices (e.g., Three Dimensional (3D) television, non-stereoscopic display, and the like), gives the user a feeling of depth, and hence adding that extra dimension to the visual content. This feeling of depth is perceived because of visual disparity of the eyes. Since the user's eyes see different versions of the same scene, the user's mind maps these differences as depth between the first image and the second image. The process of producing and displaying a stereoscopic image from two images is well known in the art and hence is thereof omitted.

One can envision that the above described method can also be implemented to capture panorama images. The present disclosure would enable the user to capture panorama images at camera image capture resolution, thereby improving the quality of panorama images.

FIG. 3 is a process flowchart illustrating a detailed method of capturing a second image of a scene for producing a stereoscopic image, according to one embodiment.

Once a first image of a scene is captured, in order to produce a stereoscopic image, another image (i.e., second image) of the same scene from a different viewpoint is captured using the non-stereoscopic camera 102. The operations 302 to 320 illustrate a process in which the electronic device 100 assists the user in capturing the second image.

At operation 302, a scene mode type set for capturing the first image is determined. The scene mode type may include a portrait mode, a landscape mode, an outdoor mode, a macro mode, and an auto scene mode. In some embodiments, the scene mode type is selected by a user prior to capture of the first image based on the distance at which the object in the scene is located from the non-stereoscopic camera 102. For example, the landscape mode is selected when the object in the scene is located far from the non-stereoscopic camera 102. Alternatively, the user may select a macro mode if the object in the scene is located very near the non-stereoscopic camera 102. In other embodiments, the scene mode type is automatically determined using methods well known in the art when the auto scene mode is selected by the user. In one implementation, when the auto scene mode is selected, the scene mode type is automatically determined by shooting a light beam at an object in the scene, calculating the time taken to return the light beam, and determining the distance of the object in the scene from the non-stereoscopic camera 102 based on the time taken to return the light beam. If the object is very near, then the scene mode type is set to macro mode. Similarly, if the object is far, the scene mode type is set to landscape mode.

At operation 304, the depth of the scene is computed based on the scene mode type. Each type of scene mode is associated with a specific depth between the first image and the second image for better perception of stereoscopic effect. For example, depth (X) for the landscape mode is less than the outdoor mode, while the depth (X) for the outdoor mode is less than the portrait mode. The depth (X) of the macro mode is highest among all modes.

Ideally, the depth (X) of the scene should not exceed a value equal to 1/30 of the total width of the first image for better three-dimensional viewing experience. Thus, the macro mode is assigned a maximum depth, i.e., X= 1/30×width of the first image. The depth value (X) for other scene mode types such as portrait mode, outdoor mode, and landscape mode is assigned based on a relative position in terms of the depth of a particular mode with respect to the macro mode. For auto scene mode, the depth (X) is computed as follows. For the purpose of illustration, consider that a minimum distance of an object is set to zero meters and a maximum distance is set to 100 meters, where the depth value (X) is from 0 to 255 if 8bit depth used. For example, if the object in the scene is positioned at a distance of 50 meters from the non-stereoscopic camera 102, then the depth value assigned to the scene mode would be equal to 128. In contrast, if the object is located at 1 meter from the non-stereoscopic camera 102, then the depth value assigned to the scene mode would be equal to 3. However, if the object is located at a distance greater than 100 meters, then the depth would be infinite value.

For capturing the second image with the depth computed in operation 304, the electronic device 100 is to be shifted horizontally (in right direction or left direction) from the position where the first image was captured. The distance by which the electronic device 100 is to be displaced horizontally depends on the depth of the object. If the depth value is higher (i.e., the object is near), then the distance by which the electronic device 100 is to be displaced from the position where the first image was captured is higher. On the contrary, if the depth is lower (i.e., the object is far), the distance by which the electronic device 100 is to be shifted is lower. As mentioned above, the depth is higher for the macro scene mode and the depth is lower for the landscape scene mode.

The user is guided to move the electronic device 100. According to the present disclosure, a guided preview screen (as shown in FIGS. 5A and 5B) is displayed on the display unit 108 which guides the user to move the electronic device 100. The guided preview screen may display a preview frame of the scene offset from the vertical edge of the display unit 108. This indicates that the electronic device 100 has to be shifted by a pre-determined distance to capture the second image from the position at which the first image was captured as detailed in the following operations.

At operation 306, the distance by which a preview frame of the scene is to be offset on the display unit 108 is computed based on the computed depth of the scene. For example, the scene type mode is set to macro mode and the depth value of the macro mode is equal 1/30×width of a first image. The distance by which a preview frame of a scene is to be offset on the display unit 108, corresponding to the depth value, is equal to 1/30×width of the display unit 108. In some embodiments, the distance by which the preview frame is to be offset is pre-computed for various depth values and stored in a lookup table with respect to the corresponding depth values for each scene type. In these embodiments, the distance corresponding to a depth value is determined using the lookup table.

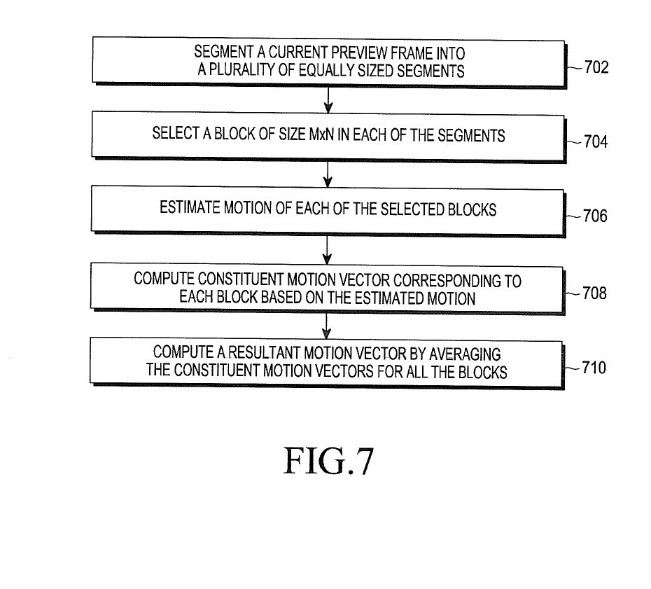

At operation 308, a preview frame of the scene is displayed at the computed distance from the vertical edge of the display unit 108 to guide the user in capturing the second image. In some embodiments, the display area, corresponding to the offset distance, adjacent to the preview frame, is occupied by a blank display region. That is, the preview frame 402 is displayed in juxtaposition with the blank display region 404 on the display unit 108 as shown in FIG. 5A. In one implementation, pixels that correspond to the blank display region are white in color. Further, the size of the blank display region is small if the depth of the object is low, while the size of the blank display region is large if the depth of the object is high. Thus, if the size of the blank display region is small, it implies that the electronic device 100 has to be moved by a small distance. However, if the size of the blank display region is large, it implies that the electronic device 100 has to be moved by a large distance. Thus, the blank display region displayed on the display unit 108 indicates that the electronic device 100 is to be displaced in a particular direction (e.g., right direction or left direction) in order to capture the second image. Accordingly, a user moves the electronic device 100 in a particular direction to automatically capture the second image. During this process, a shift in the electronic device 100 is detected, at operation 310. The movement in the electronic device 100 is detected based on a movement of a preview frame of the scene. In some embodiments, the movement of the preview frame is determined based on a resultant motion vector. The operations involved in computing the resultant motion vector is illustrated in FIG. 7.

At operation 312, it is determined whether the electronic device 100 is displaced in the correct direction based on the direction of the resultant motion vector. At operation 314, the size of the blank display region is reduced and the size of the preview frame is increased substantially simultaneously on the display unit 108 as the electronic device 100 is shifted towards the correct direction. This process assists the user in moving the electronic device 100 by the distance computed at operation 306. Based on the size of the blank display region displayed on the display unit 108, the user continues to move the electronic device 100 until the blank display region disappears (i.e., the pre-determined offset becomes zero) and the preview frame occupies the display unit 108 in entirety. However, if it is determined that the electronic device 100 is shifted in the incorrect direction, then at operation 316, the user is notified that the electronic device 100 is shifted in the incorrect direction using any of the example techniques as detailed below.

In an implementation, edges of the preview frame are highlighted in a first predefined color (e.g., green) if the electronic device 100 is shifted in the correct direction. If the electronic device 100 is moved in the incorrect direction, edges of the preview frame are highlighted in a second pre-defined color (e.g., red). In another implementation, a first audio signal indicating that the electronic device 100 is being moved in the correct direction is generated. Alternatively, a second audio signal indicating that the electronic device 100 is being moved in the incorrect direction is generated. In yet another implementation, brightness of the display unit 108 is increased indicating that the electronic device 100 is being moved in the correct direction. Similarly, brightness of the display unit 108 is reduced indicating that the electronic device 100 is being moved in the wrong direction.

At operation 318, it is determined whether the size of the blank display region displayed on the display unit 108 is substantially equal to zero. In other words, it is determined whether the electronic device 100 is displaced by the distance computed at operation 306. If the size of the blank display region is substantially equal to zero, then at operation 320, the second image of the scene is captured. If the size of the blank display region is not equal to zero, then the operations 310 to 318 are repeated until the size of the blank display region becomes substantially equal to zero. In some embodiments, an indication (e.g., visual indication, sound indication, and the like) to capture the second image is displayed on the display unit 108 when the blank display region disappears from the display unit 108 so that the user triggers an image capture signal. In other embodiments, the second image is automatically captured using the non-stereoscopic camera 102 when the blank display region disappears from the display unit 108.

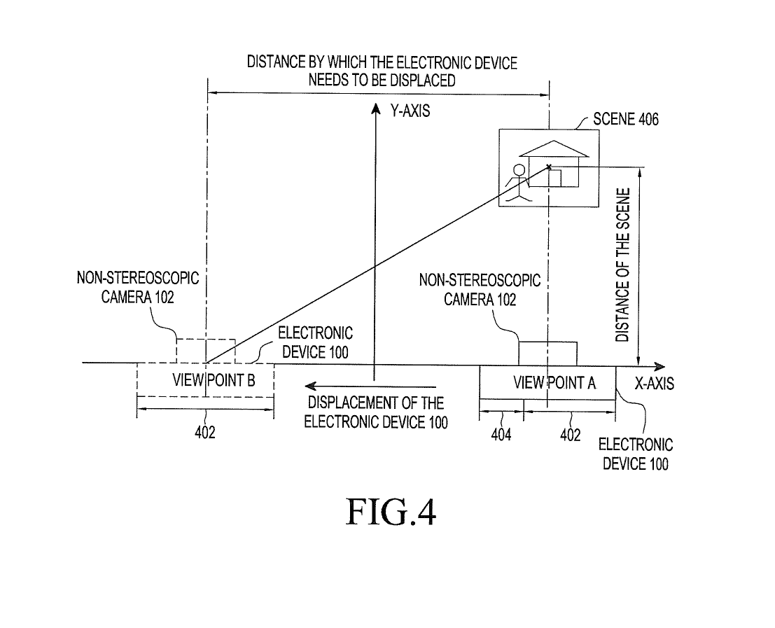

FIG. 4 is a schematic view illustrating capturing of a first image and a second image of a scene 406 from different viewpoints using the non-stereoscopic camera 102, according to one embodiment. Consider that a user wishes to produce a stereoscopic image of the scene 406 using the electronic device 100. Also consider that the user captures a first image of the scene 406 from a viewpoint A. In order to produce a stereoscopic image, another image (i.e., a second image) of the same scene 406 from another viewpoint (e.g., viewpoint B) may be captured. When the user triggers a signal for capturing a second image, the stereoscopic image generation unit 104 computes distance by which the electronic device 102 is to be moved by the user based on a scene mode type and depth of the scene 406.

Based on the computation, the stereoscopic image generation unit 104 displays a preview frame 402 in juxtaposition with a blank display region 404 on the display unit 108 as shown in FIG. 5A. The blank display region 404 corresponds to the distance by which the electronic device 100 is to be moved to capture the second image of the scene 406 from the viewpoint B. As the user moves the electronic device 100 from the viewpoint A to the viewpoint B, the stereoscopic image generation unit 104 decreases the size of the blank display region 404 and increases the size of the preview frame 402 as shown in FIG. 5B. When the user has covered the distance, the preview frame 402 entirely occupies the display unit 108 and the blank display region 404 disappears indicating the user that the second image can be captured, as shown in FIG. 5C. Accordingly, the stereoscopic image generation unit 104 captures the second image of the scene 406 from the viewpoint B.

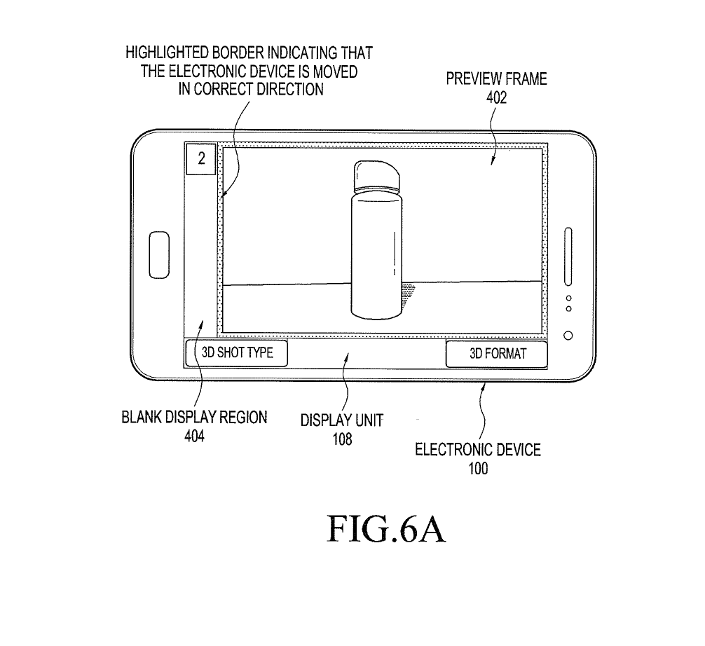

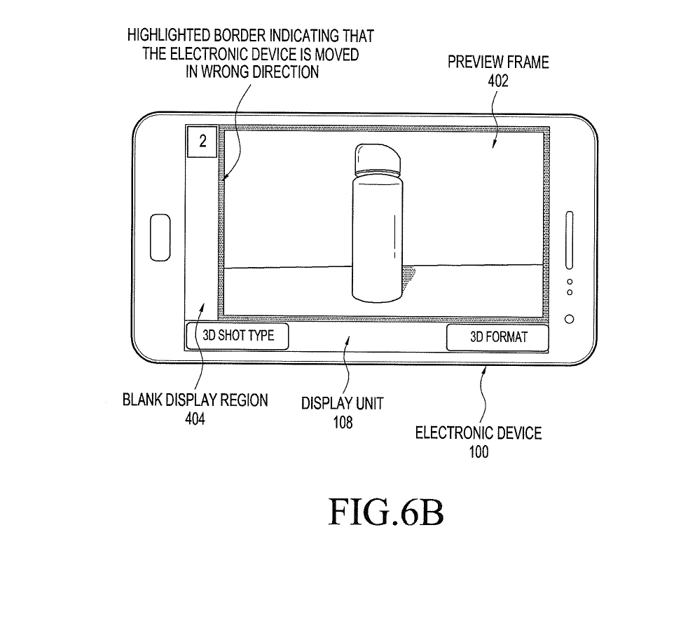

FIGS. 6A and 6B are screenshot views of a guided preview screen displaying whether the electronic device 100 is shifted in the correct direction or wrong direction. When the user is shifting the electronic device 100 to capture the second image from the viewpoint B, the user may move in the correct direction or an incorrect direction. When the user is moving the electronic device 100 in the correct direction, for example, the stereoscopic image generation unit 104 highlights the border of the guided preview screen in a light grey color as shown in FIG. 6A. However, when the stereoscopic image generation unit 104 determines that the user is shifting the electronic device 100 in the wrong direction, for example, the stereoscopic image generation unit 104 highlights the border of the guided preview screen with a dark grey color as shown in FIG. 6B. Alternatively, it is understood that other types of indications/warnings may be provided to the user by the electronic device 100.

FIG. 7 is a process flowchart illustrating a method of computing a resultant motion vector of a preview frame, according to one embodiment. When the user is moving the electronic device 100, the preview frame displayed on the display unit 108 may need to be changed. In some embodiments, the movement of the electronic device 100 is determined based a value of a resultant motion vector. The resultant motion vector is computed in the manner described below.

At operation 702, the current preview frame, displayed on the display unit 108, is segmented into a plurality of equally sized segments. The number of segments formed from the preview frame depends upon the desired accuracy and processing power of the electronic device 100. If the preview frame is divided into a large number of segments, then the resultant motion vector would be more accurate. In some embodiments, the number of segments into which the preview frame is to be divided is pre-configured based on the accuracy level desired by a user and the processing power of the electronic device 100.

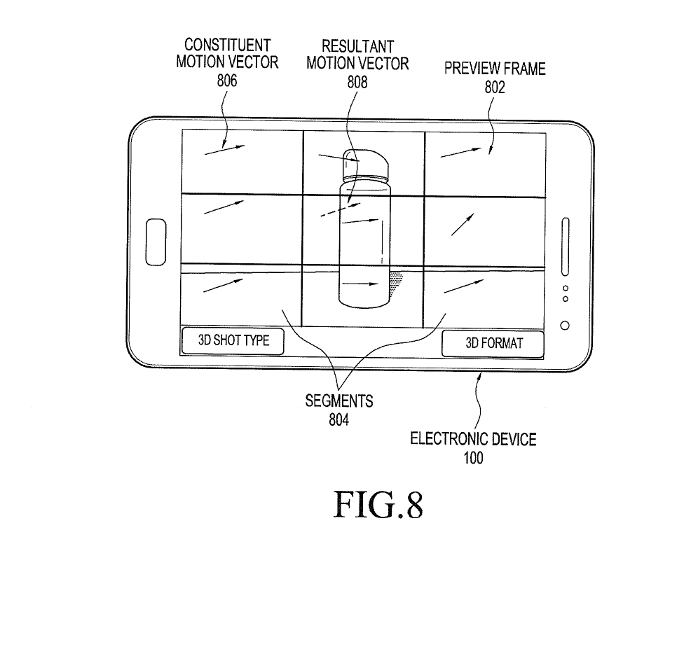

At operation 704, a block of size m×n (e.g., m horizontal pixels×n vertical pixels) is selected in each of the segments. For example, a block centrally located in each of the segments may be selected. At operation 706, motion of the selected block of the current preview frame with respect to the corresponding block of the previous preview frame is estimated. In some embodiments, the motion of a block is estimated using one of a number of block matching algorithms well known in the art. For example, a full search algorithm may be applied to compute the motion of a block. At operation 708, a constituent motion vector corresponding to each block is computed based on the motion of each block. At operation 710, a resultant motion vector is computed by averaging the constituent motion vector corresponding to each block for all block. Examples of a constituent motion vector for each block and a resultant motion vector associated with a preview frame are shown in FIG. 8.

FIG. 8 is a screenshot depicting constituent motion vectors and a resultant motion vector associated with a preview frame. In FIG. 8, a preview frame 802 is divided into nine equally sized segments 804. A block (not shown) is selected in each of the nine equally sized segments 804. A constituent motion vector 806 computed for each of the nine segments 804 is shown as solid line arrows while a resultant motion vector 808 computed for the entire preview frame is shown as a dotted line arrow. The resultant motion vector assists in determining movement of the electronic device 100 and the direction of movement.

FIG. 9 is a process flowchart illustrating a method of post processing the second image with respect to the first image, according to one embodiment. While the guided preview screen guides the user to capture the second image from a different viewpoint, the second image captured subsequent to the first image may have glitches with respect to the first image. For the better perception of stereoscopic effect, the first image and the second image should have a perfect horizontal alignment. In case of misalignment, operations 902 to 908 are performed on the second image to make the second image horizontally aligned.

At operation 902, corner edges of the first image are identified. One skilled in the art would appreciate that the present disclosure determines corner edges in the first image using a well known corner detection algorithm such as Harris and Stephens corner detection algorithm, Shi-Thomas corner detection algorithm, and the like. At operation 904, a position corresponding to the corner edges of the first image is determined in the second image. For example, the position corresponding to the corner edges is determined in the second image using an optical flow algorithm such as Lucas-Kanade optical flow algorithm. The position of the corner edges in the second image help determine the amount of misalignment between the first image and the second image.

At operation 906, the motion of the second image with respect to the first image is computed based on the position of the corner edges of the first image in the second image. In some embodiments, the displacement of each corner edge in the first image and the corresponding position in the second image is computed and an average of the displacement associated with the four corner edges is determined. At operation 908, the second image is horizontally aligned with the first image using the y component (i.e., vertical displacement) of the computed motion.

The present embodiments have been described with reference to specific example embodiments; it will be evident that various modifications and changes may be made to these embodiments without departing from the broader spirit and scope of the various embodiments. Furthermore, the various devices, units, modules, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of generating stereoscopic images using a non-stereoscopic camera, comprising:
capturing a first image of a scene using a non-stereoscopic camera of an electronic device;
computing a depth of the scene;
displaying a preview frame of the scene in juxtaposition with a blank display region on a display unit of the electronic device based on the computed depth of the scene, wherein the blank display region is indicative of the distance by which the electronic device is to be moved to capture a second image;
capturing the second image of the scene when the blank display region disappears from the display unit; and
generating a stereoscopic image of the scene using the first image and the second image.

2. The method of claim 1, further comprising:
displaying the stereoscopic image of the scene on the display unit of the electronic device.

3. The method of claim 1, wherein the first image and the second image correspond to distinct viewpoints of the scene.

4. The method of claim 1, wherein computing the depth of the scene comprises:
determining a scene mode type associated with the captured first image; and
computing the depth of the scene based on the scene mode type.

5. The method of claim 4, wherein the scene mode type comprises a macro mode, a portrait mode, a landscape mode, an outdoor mode, or an auto scene mode.

6. The method of claim 1, wherein displaying the preview frame of the scene in juxtaposition with the blank display region on the display unit based on the computed depth of the scene comprises:
computing a distance by which the preview frame is to be offset; and
displaying the preview frame at the computed distance from a vertical edge of the display unit.

7. The method of claim 1, wherein capturing the second image of the scene when the blank display region disappears from the display unit comprises:
detecting a movement in the electronic device;
determining whether the electronic device is being moved in a correct direction;
substantially simultaneously reducing the size of the blank display region and increasing the size of the preview frame on the display unit as the electronic device is moved in the correct direction;
determining whether the size of the blank display region displayed on the display unit has become substantially equal to zero; and
capturing the second image of the scene when the size of the blank display region has become substantially equal to zero.

8. The method of claim 1, further comprising:
determining whether the electronic device is being moved in a correct direction;
highlighting edges of the preview frame with a first pre-defined color on the display unit when the electronic device is being moved in the correct direction; and
highlighting edges of the preview frame with a second pre-defined color on the display unit when the electronic device is being moved in an incorrect direction.

9. The method of claim 1, further comprising:
determining whether the electronic device is being moved in a correct direction;
generating a first audio signal when the electronic device is being moved in the correct direction; and
generating a second audio signal when the electronic device is being moved in an incorrect direction.

10. The method of claim 1, further comprising:
determining whether the electronic device is being moved in a correct direction;
increasing a brightness of the display unit when the electronic device is being moved in the correct direction; and
reducing the brightness of the display unit when the electronic device is being moved in an incorrect direction.

11. The method of claim 7, wherein detecting the movement of the electronic device comprises:
dividing a current preview frame of the scene into a plurality of equal sized segments;
selecting a block centrally located in each of the plurality of segments;
computing a motion vector associated with the selected block of the each segment;
computing a resultant motion vector by averaging the motion vector associated with the block associated with the each segment; and
detecting a shift in the electronic device based on the resultant motion vector.

12. The method of claim 1, further comprising:
identifying corner edges associated with the first image;
determining a position corresponding to the corner edges associated with the first image in the second image;
estimating a motion of the second image with respect to the first image based on the position corresponding to the corner edges in the second image; and
aligning the second image with the first image based on the estimated motion.

13. A device comprising:
a non-stereoscopic camera;
a stereoscopic image generation unit configured to:
capture a first image of a scene using the non-stereoscopic camera;
compute a depth of the scene for producing a stereoscopic effect;
provide a guided preview screen which displays a preview frame of the scene in juxtaposition with a blank display region, where the size of the blank display region is based on the computed depth of the scene;
generate a capture signal to capture a second image of the scene when the guided preview screen is entirely occupied by the preview frame;
capture the second image of the scene based on the capture signal; and
generate a stereoscopic image of the scene using the first image and the second image.

14. The device of claim 13, further comprising:
a display unit configured for displaying the stereoscopic image of the scene.

15. The device of claim 13, wherein the stereoscopic image generation unit is configured to:
determine a scene mode type associated with the captured first image; and
compute the depth of the scene based on the scene mode type.

16. The device of claim 13, wherein the stereoscopic image generation unit is configured to:
compute a distance by which the preview frame is to be offset; and
display the preview frame at the computed distance from a vertical edge of the display unit.

17. The device of claim 16, wherein the stereoscopic image generation unit is configured to:
detect a movement in the non-stereoscopic camera;
determine whether the non-stereoscopic camera is being moved in a correct direction;
substantially simultaneously reduce the size of the blank display region and increase the size of the preview frame as the non-stereoscopic camera is moved in the correct direction;
determine whether the size of the blank display region displayed on the guided preview screen has become substantially equal to zero; and
generate a capture notification indicating to capture the second image of the scene when the size of the blank display region has become substantially equal to zero.

18. The device of claim 13, wherein the stereoscopic image generation unit is configured to:
determine whether the non-stereoscopic camera is being moved in a correct direction;
highlight edges of the preview frame with a first pre-defined color on the display unit when the non-stereoscopic camera is being moved in the correct direction; and
highlight edges of the preview frame with a second pre-defined color on the display unit when the non-stereoscopic camera is being moved in an incorrect direction.

19. The device of claim 13, wherein the stereoscopic image generation unit is configured to:
determine whether the non-stereoscopic camera is being moved in a correct direction;
generate a first audio signal when the non-stereoscopic camera is being moved in the correct direction; and
generate a second audio signal when the non-stereoscopic camera is being moved in an incorrect direction.

20. The device of claim 13, wherein the stereoscopic image generation unit is configured to:
determine whether the non-stereoscopic camera is being moved in a correct direction;
increase a brightness of the guided preview screen when the non-stereoscopic camera is being moved in the correct direction; and
reduce the brightness of the guided preview screen when the non-stereoscopic camera is being moved in an incorrect direction.

21. An apparatus comprising:
a microprocessor; and
a memory coupled to the microprocessor, the memory comprising a guided preview module stored in the form of an executable program, wherein the microprocessor, when executing the executable program, is configured to:
compute a depth of a scene whose first image is captured from a first viewpoint using a non-stereoscopic camera;
generate a guided preview screen which displays a preview frame of the scene in juxtaposition with a blank display region, where the size of the blank display region corresponds to the computed depth of the scene; and
generate a capture notification to capture a second image of the scene when the guided preview screen is entirely occupied by the preview frame such that the second image of the scene is captured from a second viewpoint using the non-stereoscopic camera.

22. The apparatus of claim 21, wherein the memory comprises an image processing module stored in the form of executable program which when executed by the microprocessor, cause the microprocessor to perform:
generating a stereoscopic image of the scene using the first image and the second image

23. The apparatus of claim 21, wherein the microprocessor is configured to:
determine a scene mode type associated with the captured first image; and
compute the depth of the scene based on the scene mode type.

24. The apparatus of claim 21, wherein the microprocessor is configured to:
compute a distance by which the preview frame is to be offset; and
display the preview frame at the computed distance from the vertical edge of the guided preview screen.

25. The apparatus of claim 24, wherein the microprocessor is configured to:
detect a movement in the non-stereoscopic camera;
determine whether the non-stereoscopic camera is being moved in a correct direction;
substantially simultaneously reduce the size of the blank display region and increase the size of the preview frame as the non-stereoscopic camera is moved in the correct direction;
determine whether the size of the blank display region displayed on the guided preview screen has become substantially equal to zero; and
generate a capture notification indicating to capture the second image of the scene when the size of the blank display region has become substantially equal to zero.

26. The apparatus of claim 21, wherein the microprocessor is configured to:
determine whether the non-stereoscopic camera is being moved in a correct direction;
highlight edges of the preview frame with a first pre-defined color when the non-stereoscopic camera is being moved in the correct direction; and
highlight edges of the preview frame with a second pre-defined color when the non-stereoscopic camera is being moved in an incorrect direction.

27. The apparatus of claim 21, wherein the microprocessor is configured to:
determine whether the non-stereoscopic camera is being moved in a correct direction;
generate a first audio signal when the non-stereoscopic camera is being moved in the correct direction; and
generate a second audio signal when the non-stereoscopic camera is being moved in an incorrect direction.

28. The apparatus of claim 21, wherein the microprocessor is configured to:
determine whether the non-stereoscopic camera is being moved in a correct direction;
increase a brightness of the guided preview screen when the non-stereoscopic camera is being moved in the correct direction; and
reduce the brightness of the guided preview screen when the non-stereoscopic camera is being moved in an incorrect direction.
